(19) United States
(12) Patent Application Publication
(10) Pub. No.: US 2008/0293031 A1
(43) Pub. Date: Nov. 27, 2008

(54) Learning system based on biological curve and learning curve of user and method therefor

(75) Inventors: Chaucer Chiu, Taipei (TW); Xin Chen, Shanghai City (CN)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/802,848

(22) Filed: May 25, 2007

(51) Int. Cl. G09B 7/00

(52) U.S. Cl. 434/322

(57) ABSTRACT

A learning system based on a biological curve and a learning curve of a user and a method therefor are provided, which utilizes the biological curve representing biological status periods of the user established by using a birth date of the user, and the learning curve corresponding to the learning status periods of the user generated by accumulating a time distribution of learning operation of the user. As for the disposition of the learning content, each content disposition control parameter corresponding to each index in the biological curve is determined with reference to the current time for the user to perform the learning operation. Next, a learning status parameter of the user is further determined according to the current time. Then, the content disposition control parameter is further adjusted with the learning status parameter. Finally, the disposition of the learning content is realized.

### BACKGROUND OF THE INVENTION

1. Field of Invention

The present invention relates to a learning system, particularly to a learning system capable of adjusting learning content disposition according to a user's biological status and learning status, and a method therefor.

2. Related Art

In early days, a learning system always has a fixed learning content disposition for users, that is, when a user wants to perform learning operation through the learning system, the learning system provides a predetermined learning content for the user to learn, and the user can only accept the learning content passively, without any dominant rights. As the disposition of the learning content is limited, such learning system does not meet the requirement of some users who usually intend to plan the learning content by themselves.

Later on, some learning systems appear which mainly emphasize on providing required learning contents for the users disposing by themselves. However, the user is not always familiar with the disposition of the learning content, when under this circumstance, the user usually spends plenty of time on learning, but achieving few learning effect. Furthermore, the disposition provided by such a learning system can only provide the user to dispose the learning content in a single aspect, for example, only partial disposition is provided on the selection of learning object or learning forms, but the factors influencing the learning effect in various aspects cannot be fully taken into consideration. Therefore, though such learning systems has more disposition flexibility compared with early learning systems, it still makes little contribution to improving the learning effect.

In fact, as for the learning in any field, the most important factor which determining whether the learning effect is notable or not is the user himself/herself, and no matter how abundant and effective the learning content disposition is, if the user is in a low learning willing status, which even cannot be completely mastered and controlled by the user, even if there are lots of preferable learning content dispositions, the largest efficiency cannot be achieved, and surely, the user's learning effect is significantly influenced.

### SUMMARY OF THE INVENTION

In view of the problems that the conventional learning system cannot provide a learning content disposition, or the user cannot completely master the technique for disposing the learning content, and the learning system only performs the learning content disposition without considering the status of the user, the present invention provides a learning system based on a biological curve and a learning curve of a user and a method therefor, which can perform the disposition of the learning content in combination with the user's biological status periods and learning status periods.

The learning system of the present invention at least comprises an operation interface unit, a biological curve generating unit, a learning curve generating unit, a learning content disposition unit, and a content database.

The method for operating the learning system of the present invention at least comprises the following steps. First of all, a time distribution for the user to perform a learning operation during a time period is accumulated, so as to generate a learning curve. Next, a biological curve is established through a biological curve model according to a birth date inputted by the user. After the learning curve and the biological curve have been generated, the following steps is performed when the user operates the learning system: (1) receiving a current time for the user to perform the learning operation, and establishing a corresponding set of content disposition control parameters according to the current time with reference to the biological curve; (2) determining a learning status parameter according to the current time with reference to the learning curve; and (3) adjusting the disposition control parameters generated previously with reference to the learning status parameter, so as to generate a corresponding learning content for the user to learn.

By utilizing the system and method of the present invention, the disposition of the learning content can meet the user's biological status and learning status in various aspects, thereby eliminating the problem that the conventional learning system has and that the user cannot master the learning content disposition, therefore achieving the purpose of improving the learning effect of the user.

The features and practice of the present invention are described in detail as below according to preferred embodiments together with accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a block diagram of the learning system and a schematic view of operating the system of the present invention;

FIG. 2 is a flow chart of a method of the present invention;

FIG. 3 is a schematic view of parameter combinating of the learning content disposition according to the present invention;

FIG. 4 is a schematic view of the relationship between the biological curve and the control parameters according to the present invention; and

FIG. 5 is a schematic view of the relationship between the learning curve and the learning status parameters according to the present invention.

### DETAILED DESCRIPTION OF THE INVENTION

The present invention provides a learning system based on a biological curve and a learning curve of a user, which is applicable for a computer executable platform, wherein the computer executable platform can be a desktop computer, a laptop computer, or a handheld computer device, which is not limited herein.

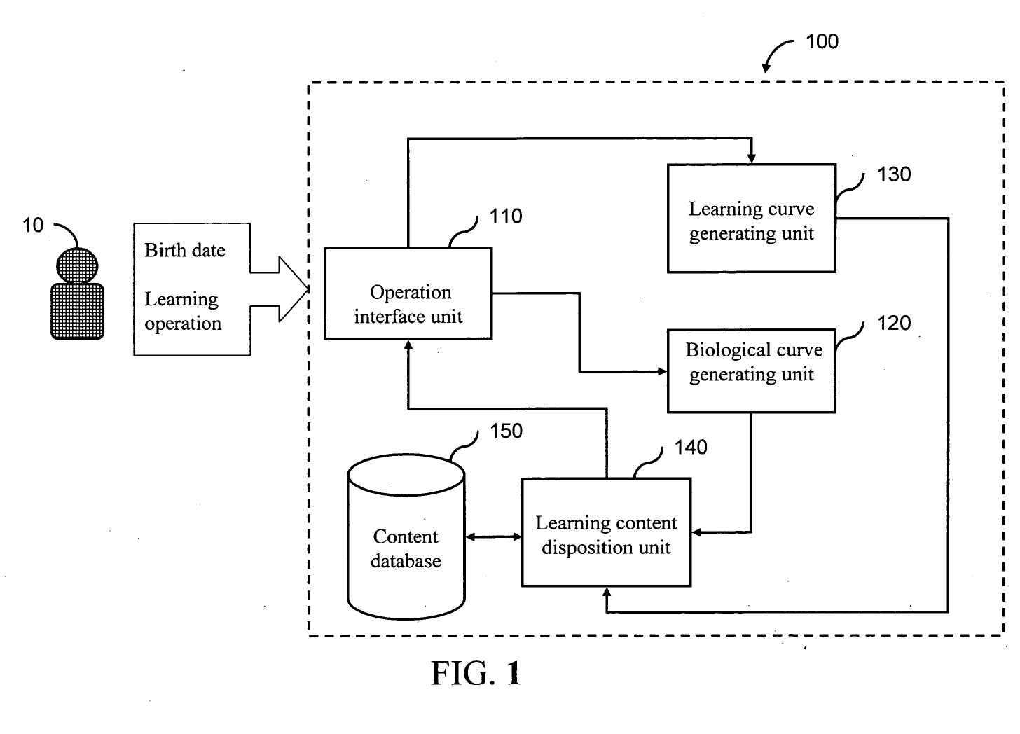

FIG. 1 is a block diagram of the learning system and a schematic view of the operation, which is illustrated as follows.

a. An operation interface unit 110, which is a graphic interface for a user 10 to receive a learning content and perform a learning operation, which can support displaying of the learning content together with a display device of the computer executable platform (not shown) and playing the learning content together with other playing hardware devices, so as to generate learning interaction with the user 10.

Among the technical features of the present invention, the generation of the biological curve and the learning curve are preconditions, and thus directing to the requirement for generating the biological curve, the operation interface unit 110 must receive a birth date inputted by the user 10 before performing the learning system based on the biological curve and learning curve of the user, so as to send the birth date to a biological curve generating unit 120 to generate the biological curve. In addition, directing to the requirement of generating the learning curve, the operation interface unit 110 must send the time the user spent on performing the learning operation each time to a learning curve generating unit 130, so as to generate the learning curve of the user 10, and the time for performing the learning operation can be obtained through a system time provided by an operation system of the computer executable platform. The generation of the biological curve and the learning curve will be further illustrated below.

When the system provides the learning content based on the biological curve and the learning curve of the user, the operation interface unit 110 must assist to generate a current time for the user 10 to perform the learning operation, and the current time still can be obtained from the system time provided by the operation system of the computer executable platform.

b. The biological curve generating unit 120 is used for establishing the biological curve with the help of the birth date inputted by the user 10 and a biological curve model, and generating a corresponding set of content disposition control parameters through formula translation according to the current time for the user 10 to perform the learning operation, with reference to corresponding indexes in the previously established biological curve, therefore performing the learning based on the biological curve and the learning curve of the user.

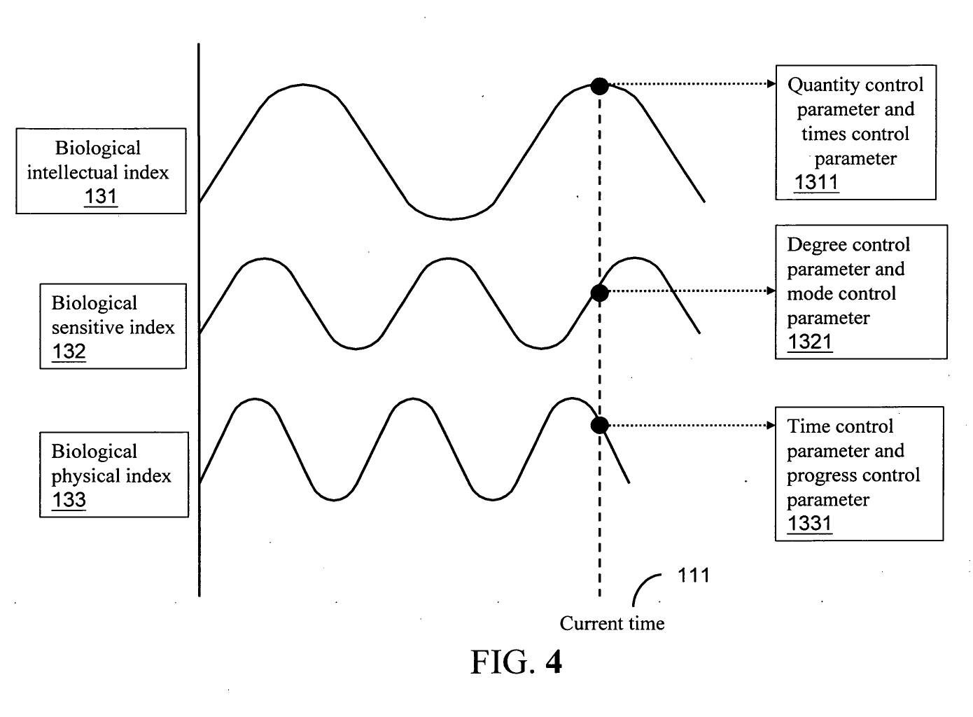

The so-called biological curve model herein can be any known biological curve model that can be used to calculate the biological status periods of the user 10 from the current time. In a preferred embodiment, a known Physical/Sensitive/Intellectual biological curve model is used to establish the biological curve, this model is mainly used for calculating the biological status periods of the user 10 at any time point based on the birth date of the user 10, and the provided biological statuses can be represented through the following indexes, including a biological intellectual index, a biological sensitive index, and a biological physical index. The Physical/Sensitive/Intellectual biological curve model is a theory deduced from the research and observation of a German doctor, an Austrian psychologist and an Austrian professor. The curve model is substantially shown in FIG. 4. In general application, three biological status curves can be generated and deduced by calculation according to the specified date of the user 10 (such as birth date in the present invention) to indicate the biological intellectual index 131, the biological sensitive index 132, and the biological physical index 133 of the user 10 separately. Each of the three curves has a different index amplitude and cycle period, and the common sense for the cycle period is that, the biological intellectual index 131 takes 33 days as a period; the biological sensitive index 132 takes 28 days as a period; and the biological physical index 133 takes 23 days as a period. The biological status of the user 10, such as intellectual, sensitive and physical statuses, at any time point can be obtained according to the above indexes.

The above-mentioned content disposition control parameters are basically control parameters for a learning content disposition unit 140 to perform the learning content disposition 141. In this embodiment, the content disposition control parameters at least include a quantity control parameter and a frequency control parameter corresponding to the biological intellectual index for the user at the current time 111, a degree control parameter and a mode control parameter corresponding to the biological sensitive index for the user at the current time 111, and a time control parameter and a progress control parameter corresponding to the biological physical index for the user at the current time 111. In other words, the present invention processes the indexes of the curve through formula translation to obtain corresponding content disposition control parameters, and the translation formulas are defined according to disposition logics of different learning contents, which are not limited herein but under a basic principle that the indexes are in direct proportion to the control parameters. As shown in FIG. 4, it can be seen from the figure that, when the user 10 performs the learning operation, through the current time 111 sent by the operation interface unit 110, corresponding index values of the biological intellectual index 131, the biological sensitive index 132, and the biological physical index 133 in the three curves can be obtained (at the current time 111, the intellectual curve of the user 10 is at the peak, the sensitive curve of the user 10 increases stably, and the physical curve decreases), and corresponding quantity control parameter and frequency control parameter 1311, degree control parameter and mode control parameter 1321, and time control parameter and progress control parameter 1331 are obtained through predetermined formula translation. After the above parameters are integrated, a set of content disposition control parameters used for the disposition of learning content is generated.

c. The learning curve generating unit 130 is used for accumulating the time distribution for the user to perform the learning system during certain period, so as to generate the learning curve. The time period is defined by the user 10 or the learning system 100 before hand, which can be a month, half a month, or a week. However, basically, the longer the accumulation time period is, the closer the obtained learning curve approaches to the actual learning state of the user 10. Each time when the user 10 performs the learning operation, the user 10 receives a time (the system time as mentioned above) sent from the operation interface unit 110, accumulates the frequency according to the corresponding specific time, and performs translation procedure according to a predetermined translation formula to generate corresponding learning status parameters.

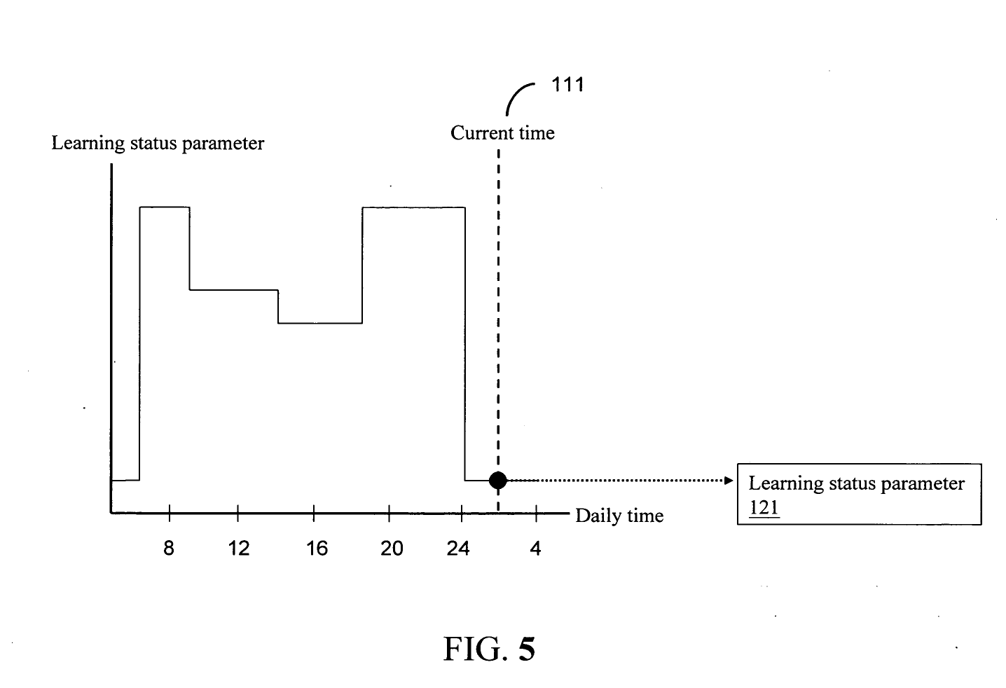

The learning curve substantially presents as a curve, and in order to illustrate clearly, the learning curve is presented in broken line in FIG. 5. As known from the figure that, the learning status periods of the user 10, especially the distribution of the learning status parameter 121 accumulated corresponding to the time spent by the user 10 on performing learning operations each day during the period, accumulates the distribution status of the learning operation time with hour as a unit. Taking what shown in the figure as an example, as for the learning status of the user 10 for performing the learning operation each day during the period, the learning status parameter 121 is relatively desirable during the period between about 7:00 am and 9:00 am, and that between 7:00 pm and 12:00 in midnight, which to some extent indicates that the user 10 prefers to learn during this period (which also indicates that the frequency is very high with better learning status). The learning status parameter 121 during the period between 12:00 in midnight and 7:00 am is relatively poor, which to some extent indicates that the user 10 does not prefer to learn during this period (which also indicates that the frequency is very low with poor learning status).

Therefore, through the learning curve, the current time 111 provided by the operation interface unit 110 when the user 10 performs the learning operation is corresponding to a learning status parameter in the learning curve, and the learning status parameter can be used to represent the current learning status of the user 10.

d. The learning content disposition unit 140 is a main unit for the disposition of the learning content, which is mainly used for adjusting each control parameter in the set of content disposition control parameters provided by the biological curve generating unit 120, according to the learning status parameters generated by the learning curve generating unit 130, and then retrieving corresponding learning content from a content database 150 according to the finally adjusted set of content disposition control parameters, so as to send the corresponding learning content to the operation interface unit 110 for the user 10 to learn.

A comparison table of learning contents corresponding to different control parameters must be set up in the learning content disposition unit 140, such that correct learning content can be selected after confirming the set of content disposition control parameters. The required learning content can be deduced through a deduction process similar to a fuzzy theory by means of inputting each control parameter, which is not described in detail herein.

However, substantially, the biological status periods of the user 10 which the biological curve presents indicates a long-term status trend, and the learning status periods of the user 10 which the learning curve presents indicates a short-term status trend. Therefore, in order to enable the disposition of the learning content to meet the actual requirements of the user 10 more desirably, the present invention particularly combines the two factors to use the leaning status to control and adjust the individual control parameter, so as to generate the content disposition control parameters applicable for disposing the learning content accordingly. One simple implementation process is using the learning status parameters to weight each control parameter, in other words, if the learning status parameter of the user 10 is at a high point, the weight of each control parameter is properly increased in the original set of content disposition control parameters, such that the whole learning content becomes more firm, such as adjusting the time control parameter to increase the learning time, adjusting the degree control parameter to increase the learning difficulty, adjusting the quantity control parameter to increase the amount of the learning content. In the contrary, if the learning status parameter is at a low point, the weight is considered to be reduced, such that the learning content becomes relatively relax. As for the process of weighting each control parameter by the learning status parameters, all the control parameters can be weighted together, or only a single control parameter is weighted, which is not limited herein.

e. The content database 150 is used for storing learning contents for the user 10 to learn, and the learning contents must be capable of being selected according to the above various control parameters, so as to provide the learning content required by the learning content disposition unit 140.

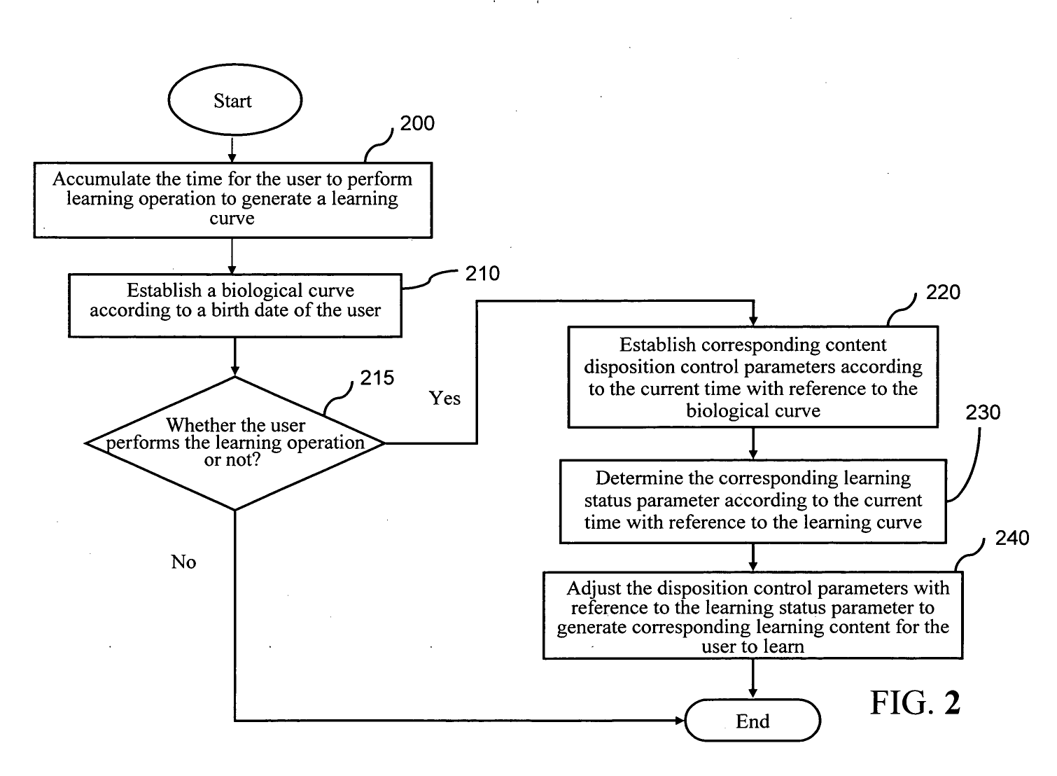

FIG. 2 is a flow chart of the method according to the present invention. First, data for the learning curve and the biological curve must be established. A time distribution for the user to perform the learning operation in a specified period is accumulated, so as to generate the learning curve (Step 200), as shown in FIG. 5. Next, the biological curve is established according to the birth date inputted by the user through the biological curve model (Step 210), as shown in FIG. 4.

After the learning curve and the biological curve have been generated, the following steps are performed each time when the user is determined to perform the learning operation (Step 215).

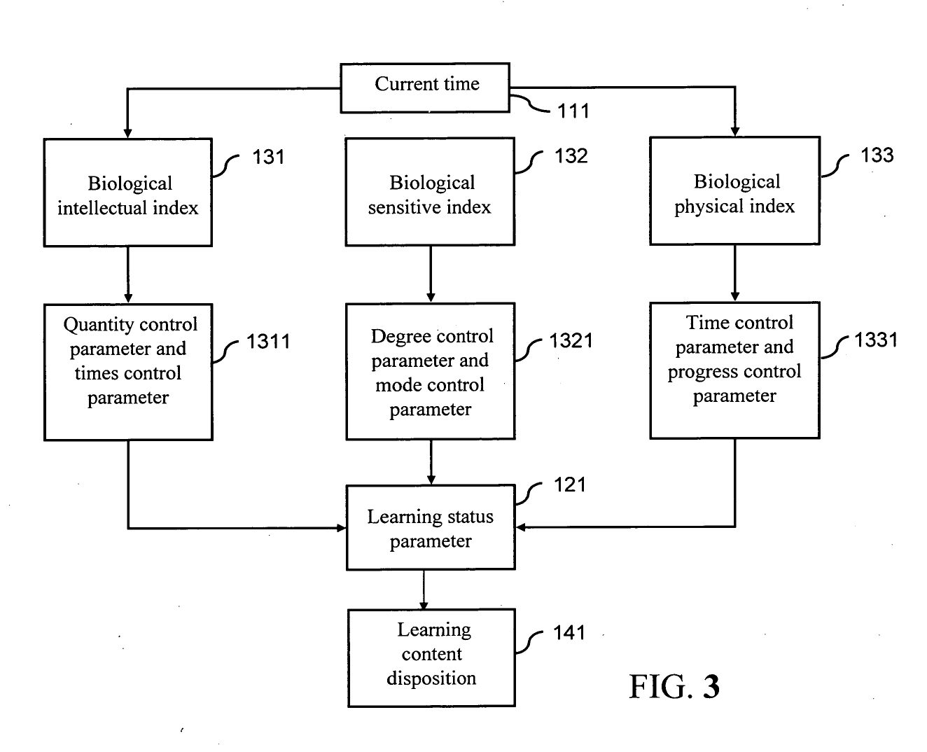

The current time 111 for the user to perform the learning operation is received, and a corresponding set of content disposition control parameters is established according to the current time 111 with reference to the biological curve (Step 220), as shown in FIG. 3. The corresponding quantity control parameter and frequency control parameter 1311 are obtained through the biological intellectual index 131, the corresponding degree control parameter and mode control parameter 1321 are obtained through the biological sensitive index 132, and the corresponding time control parameter and progress control parameter 1331 are obtained through the biological physical index 133, and the corresponding process for generating the parameters has been described above, which thus will not be described herein any more.

In addition, the corresponding learning status parameter 121 is determined according to the current time 111 with reference to the learning curve (Step 230). Finally, the set of content disposition control parameters is adjusted with reference to the learning status parameter 121, and corresponding learning content is retrieved according to the adjusted set of content disposition control parameters for the user to learn (Step 240).

The present invention mainly emphasizes on the disposition of the learning content, each content disposition control parameter corresponding to each index in the biological curves is determined with reference to the current time for the user to perform the learning operation, the learning status parameter of the user is further determined according to the current time, and then, the content disposition control parameter is further adjusted by the learning status parameter. Therefore, the disposition of the learning content is finally realized, which can meet both the biological status and learning status of the user, thereby achieving the purpose of thoroughly improving the user's learning effect.

The invention as described hereinabove-will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A learning method based on a biological curve and a learning curve of a user, comprising:
accumulating a time distribution for the user to perform a learning operation during a period, so as to generate a learning curve;
receiving a birth date inputted by the user, and establishing a biological curve through a biological curve model; and
wherein after generating the learning curve and the biological curve, it comprises following steps when the user performs the learning operation:
receiving a current time for the user to perform the learning operation, and establishing a corresponding set of content disposition control parameters according to the current time with reference to the biological curve;
determining a learning status parameter according to the current time with reference to the learning curve; and
adjusting the set of content disposition control parameters with reference to the learning status parameter, so as to generate corresponding learning content for the user to learn.

2. The learning method based on a biological curve and a learning curve of a user as claimed in claim 1, wherein the learning curve is used for representing learning status periods of the user, recording a frequency for the user to perform the learning operation in each hour per day accumulated during the learning status period, and the learning status parameter is obtained by formula translation with the frequency.

3. The learning method based on a biological curve and a learning curve of a user as claimed in claim 1, wherein the biological curve model is a Physical/ Sensitive/ Intellectual biological curve model.

4. The learning method based on a biological curve and a learning curve of a user as claimed in claim 3, wherein the biological curve is based on the birth date, and is used for representing biological status periods of the user at any time point, which at least comprises a biological intellectual index, a biological sensitive index, and a biological physical index.

5. The learning method based on a biological curve and a learning curve of a user as claimed in claim 4, wherein the set of content disposition control parameters at least comprises a quantity control parameter and a frequency control parameter corresponding to the biological intellectual index, a degree control parameter and a mode control parameter corresponding to the biological sensitive index, and a time control parameter and a progress control parameter corresponding to the biological physical index for the user at the current time.

6. The learning method based on a biological curve and a learning curve of a user as claimed in claim 5, wherein the quantity control parameter and the frequency control parameter are obtained through formula translation with the biological intellectual index, the degree control parameter and the mode control parameter are obtained through formula translation with the biological sensitive index, and the time control parameter and the progress control parameter are obtained through formula translation with the biological physical index.

7. The learning method based on a biological curve and a learning curve of a user as claimed in claim 5, wherein the learning status parameter is used for weighting the quantity control parameter, the frequency control parameter, the degree control parameter, the mode control parameter, the time control parameter, and the progress control parameter respectively.

8. A learning system based on a biological curve and a learning curve of a user, at least comprising:
a content database, for storing a learning content for the user to learn;
an operation interface unit, for the user to perform a learning operation, thus generating a current time of the learning operation, and also used for receiving a birth date inputted by the user;
a biological curve generating unit, for establishing a biological curve through the birth date and a biological curve model, and establishing a corresponding set of content disposition control parameters according to the current time with reference to the biological curve;
a learning curve generating unit, for accumulating a time distribution for the user to perform the learning operation during a period, so as to generate a learning curve, and determining a learning status parameter according to the current time with reference to the learning curve; and
a learning content disposition unit, for adjusting the set of content disposition control parameters with reference to the learning status parameter, so as to generate corresponding learning content by means of retrieving from the content database for the user to learn.

9. The learning system based on a biological curve and a learning curve of a user as claimed in claim 8, wherein the learning curve is used for representing learning status periods of the user, recording a frequency for the user to perform the learning operation in each hour per day accumulated during the learning status period, and the learning status parameter is obtained through formula translation with the frequency.

10. The learning system based on a biological curve and a learning curve of a user as claimed in claim 8, wherein the biological curve model is a Physical/Sensitive/Intellectual biological curve model.

11. The learning system based on a biological curve and a learning curve of a user as claimed in claim 10, wherein the biological curve is based on the birth date, for representing biological status periods of the user at any time point, which at least comprises a biological intellectual index, a biological sensitive index, and a biological physical index.

12. The learning system based on a biological curve and a learning curve of a user as claimed in claim 11, wherein the set of content disposition control parameters at least comprises a quantity control parameter and a frequency control parameter corresponding to the biological intellectual index, a degree control parameter and a mode control parameter corresponding to the biological sensitive index, and a time control parameter and a progress control parameter corresponding to the biological physical index for the user at the current time.

13. The learning system based on a biological curve and a learning curve of a user as claimed in claim 12, wherein the quantity control parameter and the frequency control parameter are obtained through formula translation with the biological intellectual index, the degree control parameter and the mode control parameter are obtained through formula translation with the biological sensitive index, and the time control parameter and the progress control parameter are obtained through formula translation with the biological physical index.

14. The learning system based on a biological curve and a learning curve of a user as claimed in claim 12, wherein the learning status parameter is used for weighting the quantity control parameter, the frequency control parameter, the degree control parameter, the mode control parameter, the time control parameter, and the progress control parameter respectively.
